(19) United States
(12) Patent Application Publication
(10) Pub. No.: US 2026/0037408 A1
(43) Pub. Date: Feb. 5, 2026

(54) SYSTEM AND METHOD FOR INTERPRETING SUPERCLASS BEHAVIOR IN DYNAMIC LANGUAGE COMPUTER CODE

(71) Applicant: CrowdStrike, Inc., Sunnyvale, CA (US)

(72) Inventors: Eyal Mamo, Tel Aviv (IL); Amir Sidis, Tel Aviv-Yafo (IL); David Ben David, Tel Aviv-Yafo (IL); Rotem Har-Chen, Tel Aviv-Yafo (IL)

(21) Appl. No.: 18/788,995

(22) Filed: Jul. 30, 2024

(51) Int. Cl. G06F 11/36; G06F 8/30; G06F 9/448

(52) U.S. Cl. CPC G06F 11/3612; G06F 8/315; G06F 9/4492

(57) ABSTRACT

A method of interpreting superclass behavior in dynamic language computer code includes generating a first code object including a first class of a plurality of classes defined by a common superclass in code of application in a dynamic programming language, generating a second code object including a second class of the plurality of classes defined by the common superclass and generating an analyzable dynamic language computer code including the first code object and the second code object. The method further includes resolving an attribute in the analyzable dynamic language computer code for each of the first code object and the second code object, performing a comparison of the attribute resolved for the first code object and the second code object, and identifying a deviation in behavior of the first class or the second class based on the comparison of the first attribute and the second attribute.

### TECHNICAL FIELD

Aspects of the present disclosure relate to detecting computer architecture drift, and more particularly, to interpreting superclass behavior in a dynamic programming language.

### BACKGROUND

A dynamic programming language is a high-level programming language which executes certain functions at runtime, which static programming languages perform during compilation. As compared to static programming languages, values, functions, and types can be dynamically determined at runtime rather than at compilation. Computer architecture drift occurs when an implementation of computer architecture differs from the intended operation of the computer architecture. Computer architecture drift can occur in dynamic programming languages due to the dynamic nature of such code at runtime.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram illustrating an example system architecture, in accordance with some embodiments of the present disclosure.

FIG. 2 is a block diagram that illustrates an example of analysis of behavior of a superclass in a dynamic programming language, in accordance with some embodiments of the present disclosure.

FIG. 3 is a block diagram illustrating an example system for analysis of behavior of a superclass in a dynamic programming language, in accordance with embodiments of the present disclosure.

FIG. 4 is a flow diagram of an example method of analysis of behavior of a superclass in a dynamic programming language, in accordance with some embodiments of the present disclosure.

FIG. 5 is a block diagram of an example computing device that may perform one or more of the operations described herein, in accordance with some embodiments of the present disclosure.

### DETAILED DESCRIPTION

Dynamic programming languages provide many advantages over static programming languages including the flexibility to be deployed in varying environments and to adjust the implementation of the application code, as necessary, at runtime of the application. For example, dynamic programming languages can modify a type or object system during runtime, such that new objects can be generated from runtime definitions and can alter the way existing types behave during runtime. Additionally, dynamic programming languages can use dynamic type systems as well as variable memory allocation.

While dynamic programming languages provide flexibility and streamlined development, the complexities of dynamic programing languages pose particular challenges in code analysis for verifying proper operation of an application or architecture prior to deployment of the application. The dynamic nature of dynamic programming languages that provide the various advantages also may cause architecture drift (e.g., implementation at runtime differing from the expected operation of code).

The present disclosure addresses the above-noted and other deficiencies by providing a monitoring environment in which objects of classes depending from a superclass are analyzed to identify and confirm behavior of the superclass. In some embodiments, code of application written in a dynamic programming language is deployed to a runtime environment. Embodiments provide a collector to identify, copy, and provide the deployed code of the application to the monitoring environment. The monitoring environment may perform static analysis of the application, resolving various transition points in the code to their final values. Additionally, the monitoring environment may perform a behavior analysis on the resolved code by performing a comparison of classes that depend from a common superclass. Because the classes that depend from the common superclass inherit properties of the superclass, the classes are likely to behave in a similar manner with respect to the inherited properties. Accordingly, the behavior of the superclass can be determined by analysis of objects depending from the superclass. Additionally, the implementations of the code for the classes (e.g., the objects) can be analyzed to confirm that they conform to the expected or intended behavior of the superclass.

In some embodiments, the monitoring environment may generate a value-transition graph that includes the transition points and their resolved values. For example, the value-transition graph may include nodes representing transition points with edges that create paths from transition points to their resolved value or transition point. Accordingly, the monitoring environment may use the value-transition graph to determine the behavior of the superclass and the various classes depending from the superclass. For example, each object for a class may correlate to a node in the value-transition graph and therefore the related values and transition points for each class can be identified from their relation in the value-transition graph.

As discussed herein, the present disclosure provides an approach that improves the operation of a computer system by providing the capability to detect architecture drift during runtime within an application in a dynamic programming language.

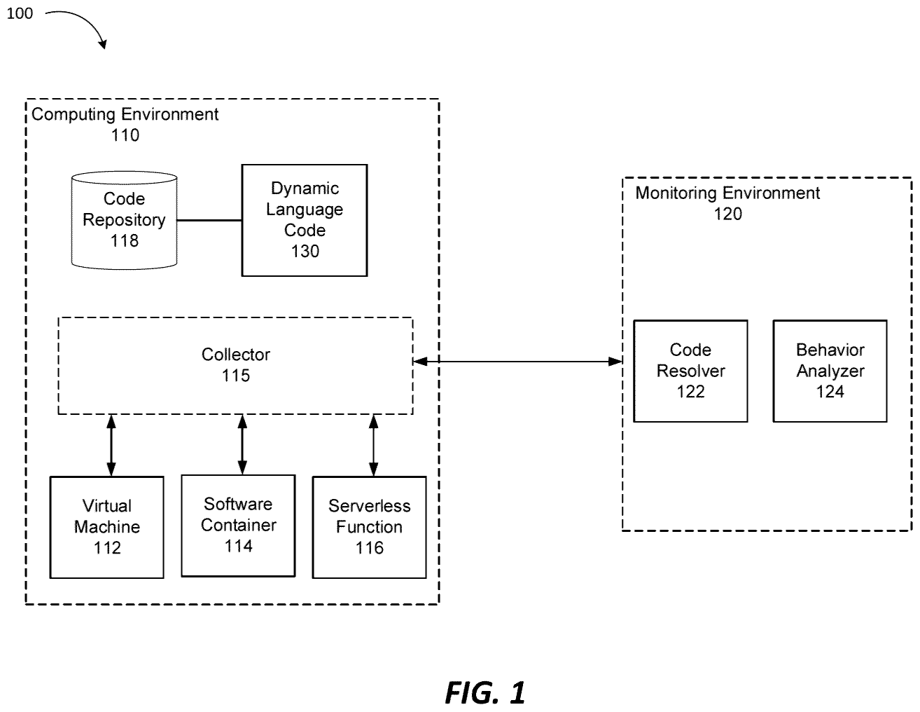

FIG. 1 illustrates an example computing architecture 100 including a computing environment 110 monitored by a monitoring environment 120, implemented in accordance with an embodiment. In an embodiment, a monitoring environment 120 is a cloud computing environment, including, for example virtual private clouds (VPCs), virtual networks (VNets), and the like. In certain embodiments, the cloud computing environment is deployed on a cloud computing infrastructure, such as Amazon® Web Services (AWS), Microsoft® Azure, Google® Cloud Platform (GCP), and the like. In some embodiments the computing environment 110 and the monitoring environment may be any data processing device, such as a server, cloud computing environment, desktop computer, a laptop computer, a mainframe computer, a personal digital assistant, a rack-mount server, a hand-held device or any other device configured to process data.

In some examples, the monitoring environment 120 is communicatively coupled with a computing environment 110. For example, in some embodiments, the computing environment 110 is a cloud computing environment, such as a virtual private cloud. In some embodiments, the computing environment 110 includes resources, principals, and the like.

In some examples, a resource is a cloud-based computing entity which provides access to a hardware, a service, a combination thereof, and the like. A resource is, for example, a virtual machine, a software container, a container node, a container pod, a serverless function, a microservice, an appliance, an application, combinations thereof, and the like. For example, in some embodiments, the computing environment 110 includes a virtual machine 112, a software container 114, a serverless function 116, and a code repository 118. In some embodiments, the virtual machine 112 may be implemented using any virtualization platform. In some embodiments, the software container 114 may be implemented utilizing any container orchestration platform. In some embodiments, a serverless function 116 may be implemented using any serverless platform for instantiating and managing deployment of serverless functions.

According to some examples, a code repository 118 may include a storage, such as a distributed storage system, on which code for applications written in a dynamic programming language is stored, for example as scripts, libraries, classes, code objects, code snippets, text files, combinations thereof, and the like.

According to some embodiments, a dynamic programming language is a high-level programming language which executes certain functions at runtime, which static programming languages perform during compilation. Some well-known examples of dynamic programming languages include Python™, Java™, Per™, and Ruby™. In dynamic languages, type systems are often not finalized and are subject to modification at runtime. Furthermore, types can be utilized in a data flow as a value, parameter, and the like. For example, a given call site does not have a constant target to its call and may change at runtime depending on a value of a given variable. This presents a challenge when performing static analysis of programs and applications writing in dynamic programming languages.

For example, in some embodiments, the code repository includes a dynamic language code 130 (e.g., code of an application written in a dynamic programming language). In some embodiments, the code resolver 122 is configured to access the code repository 118 in order to access the dynamic language code 130.

In some embodiments, a resource of the computing environment 110 is configured to obtain a copy of the dynamic language code 130 and execute the code on the resource. For example, in an embodiment, the virtual machine 112 is configured to download a copy of the dynamic language code 130 from the code repository 118 and execute the copy of the dynamic language code 130 on the virtual machine 112. In some embodiments, a resource of the computing environment 110 is configured to install a collector 115. In other embodiments, the resource of the computing environment 110 is instantiated with the collector 115 (e.g., the image of the resource includes the collector 115). In an alternative embodiment, the collector 115 may be deployed to a separate resource or computing entity external to the resource executing the dynamic language code 130. In an embodiment, the collector 115 is configured to detect a dynamic language code executed on the resource (e.g., the copy of the dynamic language code 130 on the virtual machine 112) and send the code to the monitoring environment 120. In some examples, the monitoring environment 120 includes a code resolver 122 and a behavior analyzer 124.

According to some embodiments, the code resolver 122 is configured to receive computer code of an application written in a dynamic programming language, and resolve the code of the application to generate a call graph. In some embodiments, a call graph includes a representation of relationships between functions in a program, dependencies between functions, values, and the like. For example, the code resolver 122 may receive analyzable code from the collector 115 that includes multiple code objects instantiated from classes that depend from a superclass being analyzed. The analysis of the multiple code objects that have been instantiated from a dynamic programming code 130 may allow for the varying behavior of classes depending from the superclass to be identified. In some examples, the behavior analyzer 124 may determine if the behavior of the multiple objects differ from an intended behavior of the superclass.

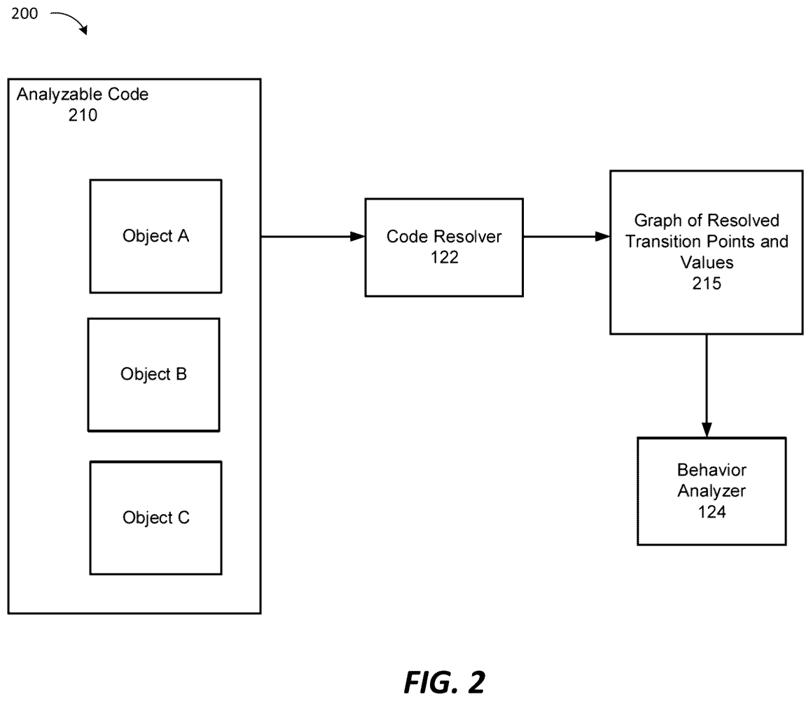

FIG. 2 illustrates an example process 200 of analyzing behavior of a superclass in a dynamic programming language, in accordance with some embodiments of the present disclosure. As depicted in FIG. 2, analyzable code 210 which may be copied or otherwise extracted from a runtime environment may include one or more objects (e.g., object A, object B, and object C) each of which may depend from and inherit attributes, functions, values, etc. from a common superclass. For example, the analyzable code may include calls to one or more classes that depend from the superclass, at which point an object for that class may be created. Each object may include implementation of the inherited attributes, functions, values, etc. of the common superclass.

In some embodiments, the code resolver 122 may identify transition points within the analyzable code 210 and the objects within the analyzable code 210. A transition point may be any assignment of a value, function, attribute, etc. within the code. Because a transition point may resolve to another transition point, the code resolver 122 may iteratively resolve the transition points until all transition points have been resolved to a final value and not to another transition point. In some embodiments, the code resolver 122 or other component may generate one or more graphs of resolved transition points and values 215. For example, the value-transition graph 215 may include nodes representing transition points with edges that create paths from transition points to their resolved value or transition point.

In some embodiments, behavior analyzer 124 may then identify and determine behavior of the classes associated with the objects of the analyzable code 210 that depend from the common superclass. Additionally, based on the identified behavior of the objects, the behavior analyzer 124 may also determine a behavior of the common superclass and whether any of the objects deviate from an intended behavior of the superclass (e.g., where implementation differs or is outside the scope of a specification for the superclass behavior). Accordingly, the behavior analyzer 124 may provide an alert or indication upon detecting behavior that deviates (e.g., by a threshold amount) from the intended behavior.

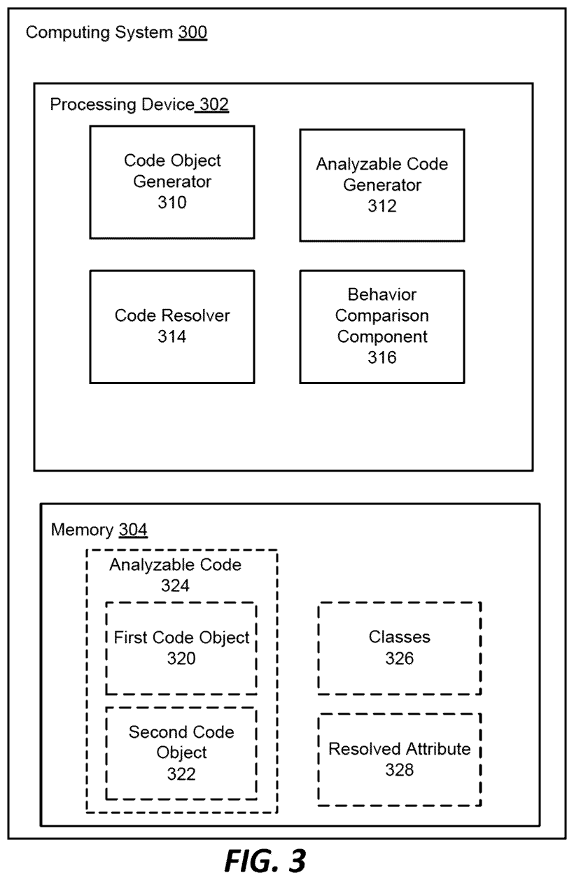

FIG. 3 block diagram depicting an example of a computing system 300 for static analysis of code in a dynamic programming language, according to some embodiments. While various devices, interfaces, and logic with particular functionality are shown, it should be understood that computing system 300 includes any number of devices and/or components, interfaces, and logic for facilitating the functions described herein. For example, the activities of multiple devices may be combined as a single device and implemented on the same processing device (e.g., processing device 302), as additional devices and/or components with additional functionality are included.

The computing system 300 includes a processing device 302 (e.g., general purpose processor, a PLD, etc.), which may be composed of one or more processors, and a memory 304 (e.g., synchronous dynamic random-access memory (DRAM), read-only memory (ROM)), which may communicate with each other via a bus (not shown).

The processing device 302 may be provided by one or more general-purpose processing devices such as a microprocessor, central processing unit, or the like. In some embodiments, processing device 302 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. In some embodiments, the processing device 302 may include one or more special-purpose processing devices such as an application specific integrated circuit (ASIC), a field programmable gate array (FPGA), a digital signal processor (DSP), network processor, or the like. The processing device 302 may be configured to execute the operations described herein, in accordance with one or more aspects of the present disclosure, for performing the operations and steps discussed herein.

The memory 304 (e.g., Random Access Memory (RAM), Read-Only Memory (ROM), Non-volatile RAM (NVRAM), Flash Memory, hard disk storage, optical media, etc.) of processing device 302 stores data and/or computer instructions/code for facilitating at least some of the various processes described herein. The memory 304 includes tangible, non-transient volatile memory, or non-volatile memory. The memory 304 stores programming logic (e.g., instructions/code) that, when executed by the processing device 302, controls the operations of the computing system 300. In some embodiments, the processing device 302 and the memory 304 form various processing devices and/or circuits described with respect to computing system 300.

The processing device 302 executes a code object generator 310, an analyzable code generator 312, a code resolver 314, and a behavior comparison component 316. In some embodiments the code object generator 310 generators one or more objects within code of an application written in a dynamic programming language. For example, the code object generator 310 may generate, in code of the application deployed within a runtime environment, a first code object 320 from a call to a first class of classes 326 that depend from a common superclass and a second code object 322 from a call to a second class of multiple classes 326 that depend from the common superclass. In some embodiments, the analyzable code generator 312 may generate analyzable code 324 including the first code object 320 and the second code object 322. In some embodiments, the analyzable code 324 may be a copy of code deployed and executing within a runtime environment.

In some embodiments, code resolver 314 may identify transition points within the code analyzable code 324. The code resolver may iteratively resolve the transition points to their final resolved values. For example, some transition points may resolve to other transition points. Accordingly, the code resolver 314 may resolve additional transition points during each iteration of transition point resolving until all transition points have been resolved to a final value or to a value placeholder (e.g., resolved attributes 328). The behavior comparison component 316 may then identify and determine the behavior of the classes 326 associated with the first code object 320 and the second code object 322 based on the resolved attributes 328. For example, the behavior comparison component 316 may identify the transition points in the analyzable code 324 corresponding to the code objects 320 and 322 and determine related transition points and values associated with the code objects 320 and 322 to identity the behavior of the classes 326 and the superclass. In some embodiments, the behavior comparison component 316 may compare resolved values such as attributes, function calls, subscripts, and inheritance of the first code object 320 and the second code object 322 to determine variations or deviations in behavior of the classes 326 and superclass from which the classes 326 depend.

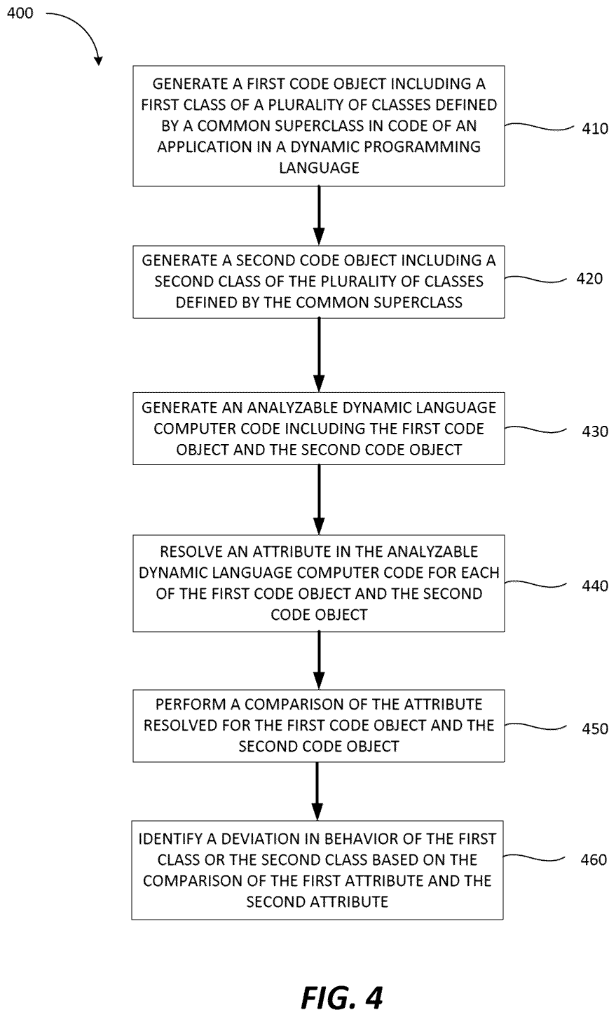

FIG. 4 is a flow diagram of a method 400 of analyzing behavior of a superclass in a dynamic programming language, in accordance with some embodiments of the present disclosure. Method 400 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 400 may be performed by monitoring environment 120, code resolver 122, and/or behavior analyzer 124 of FIG. 1.

With reference to FIG. 4, method 400 illustrates example functions used by various embodiments. Although specific function blocks (“blocks”) are disclosed in method 400, such blocks are examples. That is, embodiments are well suited to performing various other blocks or variations of the blocks recited in method 400. It is appreciated that the blocks in method 400 may be performed in an order different than presented, and that not all of the blocks in method 400 may be performed.

With reference to FIG. 4, method 400 begins at block 410, where processing logic (e.g., computing environment 110 and/or monitoring environment 120) generates a first code object including a first class of a plurality of classes defined by a common superclass in code of an application in a dynamic programming language. In some embodiments, processing logic detects at least one class in the dynamic language computer code. In some examples, each of the detected classes is defined by the common superclass.

At block 420, processing logic (e.g., computing environment 110 and/or monitoring environment 120) generates a second code object including a second class of the plurality of classes defined by the common superclass. In some examples, to generate the first code object including the first class includes instantiating the first code object in a runtime environment from a call to the first class within the code of the application.

A block 430, processing logic (e.g., computing environment 110 and/or monitoring environment 120) generates an analyzable dynamic language computer code including the first code object and the second code object. In some examples, the processing logic may copy or extract the first code object and the second code object from one or more runtime environments in which the application is deployed. The processing logic may then provide the analyzable dynamic code including the first and second code objects to a monitoring environment for analyzing the code as deployed to the runtime environment.

At block 440, processing logic (e.g., computing environment 110 and/or monitoring environment 120) resolves an attribute in the analyzable dynamic computer code for each of the first code object and the second code object. In some examples, resolving the attributes includes resolving a transition point within the analyzable code to the attribute. In some embodiments, a transition point may be resolved iteratively. For example, a first function is called in a portion of code and receives a value from a second function. The first function is therefore resolved to the second function during a first iteration. At the next iteration, the second function may be resolved to the final value or attribute.

In some examples, a transition point is a called name, a called function, a called library, a called class, a parent definition, an attribute definition, a subscript, or the like, or a combination thereof. According to some examples, processing logic resolves detected transition points until an iteration where no additional transition points are resolved. For example, an iteration where no values are added to the call graph is the iteration where resolution stops because all transition points have been resolved.

At block 450, processing logic (e.g., monitoring environment 120) performs a comparison of the attribute resolved for the first code object and the second code object. For example, processing logic may identify the transition points in the analyzable code corresponding to the first and second code objects and determine related transition points and values associated with the first and second code objects to identity the behavior of the classes and the common superclass. In some embodiments, processing logic may compare resolved values such as attributes, function calls, subscripts, and inheritance of the first code object and the second code object.

In some embodiments, processing logic may resolve a call in the analyzable dynamic language computer code for each of the first code object and the second code object. In some examples, processing logic may perform a comparison of the call resolved for the first code object and the second code object. In some examples, the processing logic may resolve a subscript in the analyzable dynamic language computer code for each of the first code object and the second code object and perform a comparison of the subscript resolved for the first code object and the second code object. In some embodiments processing logic may resolve an inheritance in the analyzable dynamic language computer code for each of the code object and the second code object and perform a comparison of the inheritance resolved for the first code object and the second code object.

In some embodiments, processing logic may resolve each of a plurality of transition points in the dynamic language computer code and generate a value graph comprising a plurality of nodes representing resolved transition points, wherein each node is connected to another resolved transition value or a value. The processing logic may further perform a comparison of the transition points associated with the first code object and the transition points associated with the second code object.

In some embodiments, resolving the attribute in the analyzable dynamic language computer code for each of the first code object and the second code object includes detecting a collection in the dynamic language computer code and representing the detected collection as a compound object including a plurality of buckets, each bucket mapping a set of key names to a set of key values. In some embodiments, resolving the attribute in the analyzable dynamic language computer code for each of the first code object and the second code object includes resolving a lookup in the dynamic language computer code by referencing a plurality of collections, the lookup including a lookup key and matching a key of a bucket of a collection of the plurality of collections to the lookup key.

At block 460, processing logic identifies variations or deviations in behavior of the first class or the second class based on the comparison of the first attribute and the second attribute. For example, the processing logic may determine, based on the resolved attributes, any deviations in behavior between the classes or the superclass from which the classes depend, as well as any deviations in behavior between an expected behavior of each class or superclass from an expected behavior. Similarly, the processing logic may identify deviations in behavior of the classes based on resolved transition points for the first and second code objects and any other attributes.

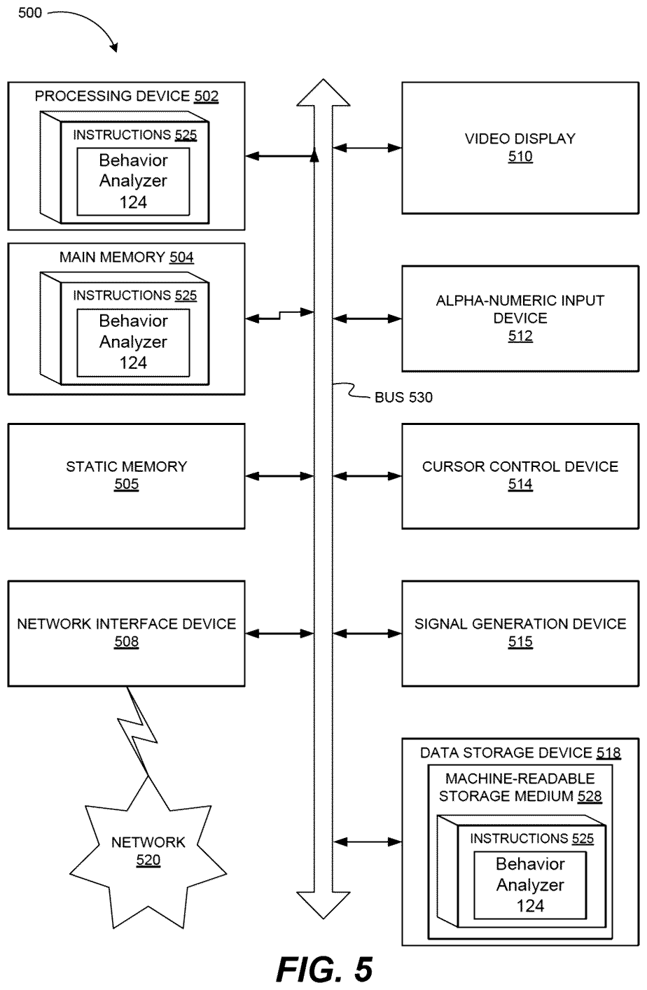

FIG. 5 illustrates a diagrammatic representation of a machine in the example form of a computer system 500 within which a set of instructions, for causing the machine to perform any one or more of the methodologies discussed herein.

In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In some embodiments, computer system 500 may be representative of a server.

The exemplary computer system 500 includes a processing device 502, a main memory 504 (e.g., read-only memory (ROM), flash memory, dynamic random-access memory (DRAM), a static memory 506 (e.g., flash memory, static random-access memory (SRAM), etc.), and a data storage device 518 which communicate with each other via a bus 530. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Computer system 500 may further include a network interface device 508 which may communicate with a network 520. Computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse) and an acoustic signal generation device 516 (e.g., a speaker). In some embodiments, video display unit 510, alphanumeric input device 512, and cursor control device 514 may be combined into a single component or device (e.g., an LCD touch screen).

Processing device 502 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 502 may also be one or more special-purpose processing devices such as an application specific integrated circuit (ASIC), a field programmable gate array (FPGA), a digital signal processor (DSP), network processor, or the like. The processing device 502 is configured to execute instructions 525, for performing the operations and steps discussed herein.

The data storage device 518 may include a machine-readable storage medium 528, on which is stored one or more sets of instructions 525 for behavior analyzer 124 (e.g., software) embodying any one or more of the methodologies of functions described herein. The instructions 525 for behavior analyzer 124 may also reside, completely or at least partially, within the main memory 504 or within the processing device 502 during execution thereof by the computer system 500; the main memory 504 and the processing device 502 also constituting machine-readable storage media. The instructions 525 for behavior analyzer 124 may further be transmitted or received over a network 520 via the network interface device 508.

The machine-readable storage medium 528 may also be used to store instructions to perform a method for intelligently scheduling containers, as described herein. While the machine-readable storage medium 528 is shown in an exemplary embodiment to be a single medium, the term “machine-readable storage medium” should be taken to include a single medium or multiple media (e.g., a centralized or distributed database, or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Unless specifically stated otherwise, terms such as “generating,” “resolving,” “performing,” “identifying” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112(f) for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given herein, but may be modified within the scope and equivalents of the appended claims.

What is claimed is:

1. A method of interpreting superclass behavior in dynamic language computer code, comprising:
generating a first code object including a first class of a plurality of classes defined by a common superclass in code of an application in a dynamic programming language;
generating a second code object including a second class of the plurality of classes defined by the common superclass;
generating an analyzable dynamic language computer code including the first code object and the second code object;
resolving, by a processing device, a first attribute in the analyzable dynamic language computer code for the first code object and a second attribute in the analyzable dynamic language code for the second code object;
performing, by the processing device, a comparison of the first attribute resolved for the first code object and the second attribute resolved for the second code object; and
identifying a deviation in behavior of the first class or the second class based on the comparison of the first attribute and the second attribute.

2. The method of claim 1, further comprising:
resolving a call in the analyzable dynamic language computer code for each of the first code object and the second code object; and
performing a comparison of the call resolved for the first code object and the second code object.

3. The method of claim 1, further comprising:
resolving a subscript in the analyzable dynamic language computer code for each of the first code object and the second code object; and
performing a comparison of the subscript resolved for the first code object and the second code object.

4. The method of claim 1, further comprising:
resolving an inheritance in the analyzable dynamic language computer code for each of the code object and the second code object; and
performing a comparison of the inheritance resolved for the first code object and the second code object.

5. The method of claim 1, further comprising:
resolving each of a plurality of transition points in the dynamic language computer code;
generating a value graph comprising a plurality of nodes representing resolved transition points, wherein each node is connected to another resolved transition value or a value; and
performing a comparison of the transition points associated with the first code object and the transition points associated with the second code object.

6. The method of claim 1, wherein resolving the attribute in the analyzable dynamic language computer code for each of the first code object and the second code object comprises:
detecting a collection in the dynamic language computer code; and
representing the detected collection as a compound object including a plurality of buckets, each bucket mapping a set of key names to a set of key values.

7. The method of claim 6, wherein resolving the attribute in the analyzable dynamic language computer code for each of the first code object and the second code object comprises:
resolving a lookup in the dynamic language computer code by referencing a plurality of collections, the lookup including a lookup key; and
matching a key of a bucket of a collection of the plurality of collections to the lookup key.

8. A system comprising:
a processing device; and
a memory to store instructions that, when executed by the processing device cause the processing device to:
generate a first code object including a first class of a plurality of classes defined by a common superclass in code of an application in a dynamic programming language;
generate a second code object including a second class of the plurality of classes defined by the common superclass;
generate an analyzable dynamic language computer code including the first code object and the second code object;
resolve a first attribute in the analyzable dynamic language computer code for the first code object and a second attribute in the analyzable dynamic language computer code for the second code object;
perform a comparison of the first attribute resolved for the first code object and the second attribute resolved for the second code object; and
identify a deviation in behavior of the first class or the second class based on the comparison of the first attribute and the second attribute.

9. The system of claim 8, wherein the processing device is further to:
resolve a call in the analyzable dynamic language computer code for each of the first code object and the second code object; and
perform a comparison of the call resolved for the first code object and the second code object.

10. The system of claim 8, wherein the processing device is further to:
resolve a subscript in the analyzable dynamic language computer code for each of the first code object and the second code object; and
perform a comparison of the subscript resolved for the first code object and the second code object.

11. The system of claim 8, wherein the processing device is further to:
resolve an inheritance in the analyzable dynamic language computer code for each of the code object and the second code object; and
perform a comparison of the inheritance resolved for the first code object and the second code object.

12. The system of claim 8, wherein the processing device is further to:
resolve each of a plurality of transition points in the dynamic language computer code;
generate a value graph comprising a plurality of nodes representing resolved transition points, wherein each node is connected to another resolved transition value or a value; and
perform a comparison of the transition points associated with the first code object and the transition points associated with the second code object.

13. The system of claim 8, wherein to resolve the attribute in the analyzable dynamic language computer code for each of the first code object and the second code object, the processing device is further to:
detect a collection in the dynamic language computer code; and
represent the detected collection as a compound object including a plurality of buckets, each bucket mapping a set of key names to a set of key values.

14. The system of claim 13, wherein to resolve the attribute in the analyzable dynamic language computer code for each of the first code object and the second code object, the processing device is further to:
resolve a lookup in the dynamic language computer code by referencing a plurality of collections, the lookup including a lookup key; and
match a key of a bucket of a collection of the plurality of collections to the lookup key.

15. A non-transitory computer readable medium, having instructions stored thereon which, when executed by a processing device, cause the processing device to:
generate a first code object including a first class of a plurality of classes defined by a common superclass in code of application in a dynamic programming language;
generate a second code object including a second class of the plurality of classes defined by the common superclass;
generate an analyzable dynamic language computer code including the first code object and the second code object;
resolve, by the processing device, a first attribute in the analyzable dynamic language computer code for the first code object and a second attribute in the analyzable dynamic language computer code for the second code object;
perform, by the processing device, a comparison of the first attribute resolved for the first code object and the second attribute resolved for the second code object; and
identify a deviation in behavior of the first class or the second class based on the comparison of the first attribute and the second attribute.

16. The non-transitory computer readable medium of claim 15, wherein the processing device is further to:
resolve a call in the analyzable dynamic language computer code for each of the first code object and the second code object; and
perform a comparison of the call resolved for the first code object and the second code object.

17. The non-transitory computer readable medium of claim 15, wherein the processing device is further to:
resolve a subscript in the analyzable dynamic language computer code for each of the first code object and the second code object; and
perform a comparison of the subscript resolved for the first code object and the second code object.

18. The non-transitory computer readable medium of claim 15, further comprising:
resolve an inheritance in the analyzable dynamic language computer code for each of the code object and the second code object; and
perform a comparison of the inheritance resolved for the first code object and the second code object.

19. The non-transitory computer readable medium of claim 15, wherein the processing device is further to:
resolve each of a plurality of transition points in the dynamic language computer code;
generate a value graph comprising a plurality of nodes representing resolved transition points, wherein each node is connected to another resolved transition value or a value; and
perform a comparison of the transition points associated with the first code object and the transition points associated with the second code object.

20. The non-transitory computer readable medium of claim 15, wherein to resolve the attribute in the analyzable dynamic language computer code for each of the first code object and the second code object, the processing device is to:
detect a collection in the dynamic language computer code; and
represent the detected collection as a compound object including a plurality of buckets, each bucket mapping a set of key names to a set of key values.
